(19) United States
(12) Patent Application Publication
(10) Pub. No.: US 2005/0146391 A1
(43) Pub. Date: Jul. 7, 2005

(54) Signal path design for modulating impedance

(76) Inventor: Sheng-Yuan Lee, Hsin-Tien City (TW)

Correspondence Address: J C PATENTS, INC., 4 VENTURE, SUITE 250, IRVINE, CA, 92618, US

(21) Appl. No.: 11/039,166

(22) Filed: Jan. 19, 2005

Related U.S. Application Data
(63) Continuation-in-part of application No. 10/423,703, filed on Apr. 25, 2003.

(30) Foreign Application Priority Data
Mar. 3, 2003 (TW) 92104353

(51) Int. Cl. H01P 5/04

(52) U.S. Cl. 333/34

(57) ABSTRACT

A signal path passing through a via hole of a substrate includes a first transmission line, a second transmission line and a via-hole transition structure. The first transmission line is arranged on an insulation layer of the substrate. The second transmission line is arranged on an insulation layer of the substrate. The via-hole transition structure has a conductive material formed at the wall of the via hole. One end of the via-hole transition structure is connected with the first transmission line while the other end thereof is connected with the second transmission line. The first transmission line has a modulating line. The impedance of the signal path is modulated by controlling the cross-sectional size of the modulating line.

### CROSS-REFERENCE TO RELATED APPLICATION

This is a continuation-in-part of application Ser. No. 10/423,703 filed on Apr. 25, 2003, now abandoned, which claims the priority benefit of Taiwan application serial No. 92104353 filed on Mar. 3, 2003.

### BACKGROUND OF THE INVENTION

1. Field of Invention

The present invention generally relates to a design of a signal path, and more particularly, to a signal path with a better impedance matching by controlling the cross-sectional size of the signal path.

2. Description of Related Art

High speed, high quality, and multi-functional products have become mainstream in the current information society. Product appearance is preferably developed based on the trends of lighter, thinner, shorter and smaller. Commonly used electronic products all have semiconductor chips and substrate that connects with the semiconductor chips. The semiconductor chips receive signals from a motherboard or outside via the signal path on the substrate, or send signals to the motherboard or outside. Therefore, the signal transmission quality of the substrate significantly impacts the operation and processing of the semiconductor chips.

Signal transmission quality of the substrate is impacted by the difference between the signal path impedance and the system impedance. If difference between the signal path impedance and the system impedance exists, the impedance non-matching phenomenon occurs and the signal reflection problem is generated. When the signal path impedance is larger than the system impedance, a positive phase signal is reflected. When the signal path impedance is smaller than the system impedance, a negative phase signal is reflected. When the signal path impedance is equal to the system impedance, no signal is reflected. This is under the ideal case, however, if the difference between the signal path impedance and the system impedance is quite big, it may cause operation malfunction of the semiconductor chips.

Generally speaking, the difference between the signal path impedance and the system impedance is bigger after the signal path of the substrate passes through the via hole. In order to reduce the difference between the signal path impedance and the system impedance, an appropriate modulation is required in general. Referring to FIG. 1 and FIG. 2, FIG. 1 schematically shows a sectional view of a conventional substrate, and FIG. 2 schematically shows a top view of each patterned line layer of the conventional substrate.

The substrate 100 comprises three layers of insulation layer 112, 114, 116, a layer of ground plane 120, and a layer of power plane 130. The ground plane 120 is deposited between the insulation layers 112 and 114, and the power plane 130 is deposited between the insulation layers 114 and 116. The substrate 100 further comprises a via hole 102 and a signal path 140. The via hole 102 passes through the insulation layer 112, 114, 116, and the signal path 140 passes through the via hole 102 of the substrate 100. The signal path 140 comprises a first transmission line 142, a second transmission line 144, and a via-hole transition structure 146. The first transmission line 142 is deposited on the insulation layer 112, the second transmission line 144 is deposited on the insulation layer 116, and the via-hole transition structure 146 has a conductive material formed at the hole wall of the via hole 102. The first transmission line 142 and the second transmission line 144 are deposited on both sides of the via-hole transition structure 146, respectively. Both ends of the via-hole transition structure 146 have via hole land 148 and 150, respectively. The via hole land 148, 150, deposited on the insulation layer 112, 116 around the via hole 102 respectively, are of a round ring shape. The via-hole transition structure 146 is electrically connected to the first transmission line 142 via the via hole land 148, and also electrically connected to the second transmission line 144 via the via hole land 150.

Regarding the parasitic capacitance, the parasitic capacitance characteristic generated between the via-hole transition structure 146 and the power plane 130 or the ground plane 120, the parasitic capacitance characteristic generated between the first transmission line 142 or the via hole land 148 and the ground plane 120, and the parasitic capacitance characteristic generated between the second transmission line 144 or the via hole land 150 and the power plane 130 are not the same. Furthermore, regarding to the parasitic inductance, the parasitic inductance generated by the via-hole transition structure 146, the parasitic inductance generated by the first transmission line 142, and the parasitic inductance generated by the second transmission line 144 are not the same. Therefore, the impedance deviation of the signal path 140 from the system impedance is rather bigger after the signal path 140 passes through the via hole 102, so that severer signal reflection phenomenon occurs on the signal transmitted through the signal path 140, to further cause the operation malfunction of the semiconductor chips.

### SUMMARY OF THE INVENTION

To solve the problem mentioned above, one object of the present invention is to provide a signal path and a method for modulating the impedance thereof, so that there is a better matching between system impedance and the impedance of the signal path after it passes through the via hole.

In order to achieve the object mentioned above, a signal path is provided. The signal path passing through a via hole of a substrate includes a first transmission line, a second transmission line and a via-hole transition structure. The first transmission line is arranged on an insulation layer of the substrate. The second transmission line is arranged on an insulation layer of the substrate. The via-hole transition structure has a conductive material formed at the wall of the via hole. One end of the via-hole transition structure is electrically connected with the first transmission line while the other end thereof is electrically connected with the second transmission line. It is characterized that the first transmission line has an equal width extended first modulating line and an equal width extended first connection line. One end of the first modulating line is electrically connected with the via-hole transition structure while the other end thereof is electrically connected with the first connection line. The line width of the first modulating line is different from the line width of the first connection line. The second transmission line has an equal width extended second modulating line and an equal width extended second connection line. One end of the second modulating line is electrically connected with the via-hole transition structure while the other end thereof is electrically connected with the second connection line. The line width of the second modulating line is different from the line width of the second connection line. The impedance of the signal path is modulated by controlling the line width of the first modulating line and the second modulating line.

According to a preferred embodiment of the present invention, the line width of the first modulating line may be larger or smaller than the line width of the first connection line, and the line width of the second modulating line may be larger or smaller than the line width of the second connection line.

In summary, according to the design of the transmission line and the method for modulating the impedance of the signal path provided by the present invention, the cross-sectional size of the transmission line is modulated to control the impedance of the signal path, so as to obtain a signal path having a better impedance matching.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 schematically shows a sectional view of a conventional substrate;

FIG. 2 schematically shows a top view of each patterned line layer of the conventional substrate;

FIG. 3 schematically shows a sectional view of the substrate of a preferred embodiment according to the present invention;

FIG. 4 schematically shows a top view of each patterned line layer of the substrate of the preferred embodiment according to the present invention under the situation that the line width of the signal path is reduced; and

FIG. 5 schematically shows a top view of each patterned line layer of the substrate of the preferred embodiment according to the present invention under the situation that the line width of the signal path is increased.

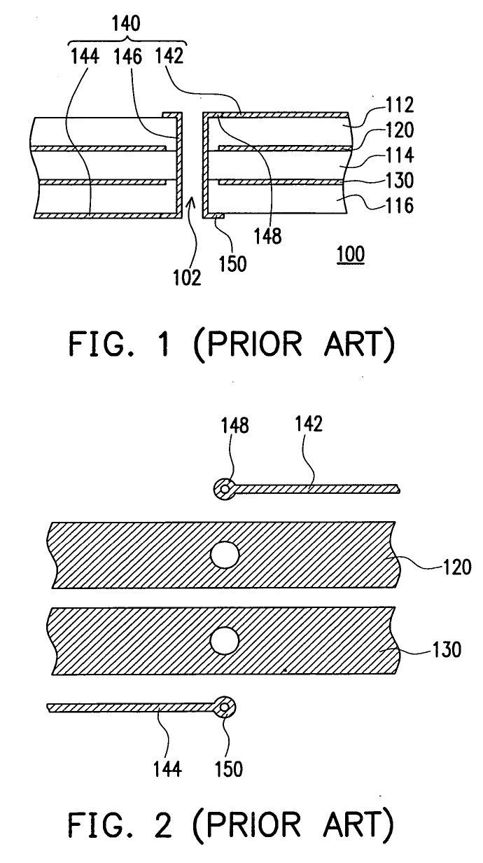

### DESCRIPTION OF THE PREFERRED EMBODIMENTS

The present invention provides a method for modulating the impedance of the signal path, in which the signal path passes through the via hole of the substrate, and the impedance of the signal path is modulated by controlling the cross-sectional size of the signal path. A preferred embodiment is used to describe the detailed content of the present invention hereinafter.

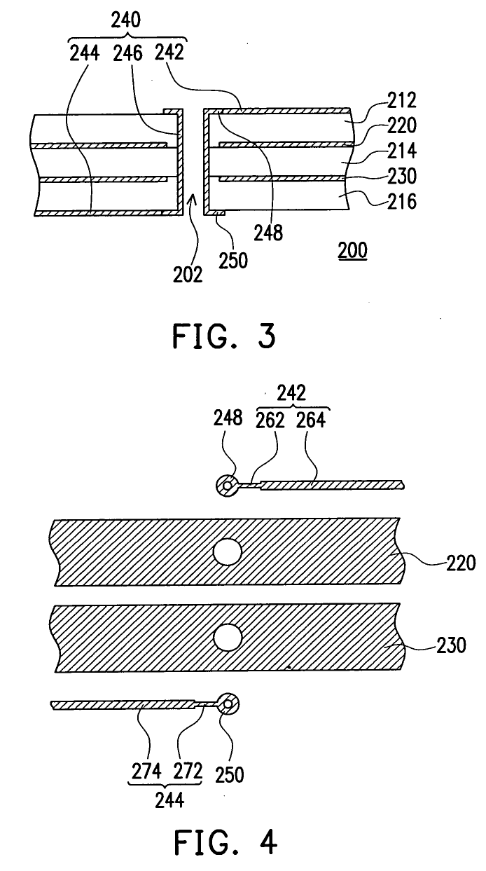

Referring to FIG. 3 and FIG. 4, wherein FIG. 3 schematically shows a sectional view of the substrate of a preferred embodiment according to the present invention, and FIG. 4 schematically shows a top view of each patterned line layer of the substrate of the preferred embodiment according to the present invention under the situation that the line width of the signal path is reduced.

For example, the substrate 200 comprises three layers of insulation layer 212, 214, 216, a layer of ground plane 220, and a layer of power plane 230. The ground plane 220 is deposited between the insulation layers 212 and 214. The power plane 230 is deposited between the insulation layers 214 and 216. The insulation layers 212, 214, 216 are made of material such as FR-4, FR-5, Bismaleimide-Triazine (BT), epoxy, polyimide, or ceramics, etc. The ground plane 220 and the power plane 230 are made of material such as copper. In general, the ground plane or the power plane is a reference plane which has different electric potential.

The substrate 200 further comprises a via hole 202 and a signal path 240. The via hole 202 passes through the insulation layers 212, 214, 216. The signal path 240 passes through the via hole 202 of the substrate 200. The signal path 240 is made of material such as copper. The signal path 240 comprises a first transmission line 242, a second transmission line 244, and a via-hole transition structure 246. The first transmission line 242 is deposited on the insulation layer 212, and the second transmission line is deposited on the insulation layer 216. The via-hole transition structure 246 has a conductive material formed at the hole wall of the via hole 202. The first transmission line 242 and the second transmission line 244 are deposited on both sides of the via-hole transition structure 246, respectively. Both ends of the via-hole transition structure 246 have via hole lands 248 and 250, respectively. The via hole lands 248, 250 that are deposited on the insulation layers 212, 216 around the via hole 202 respectively, are of a round ring shape. The via-hole transition structure 246 is electrically connected to the first transmission line 242 via the via hole land 248, and also electrically connected to the second transmission line 244 via the via hole land 250. A signal may be transmitted, for example, from the first transmission line 242 to the second transmission line 244 via the via-hole transition structure 246.

In other applications, the via-hole transition structure of the signal path is not limited to pass through three insulation layers, optionally, it can pass through one insulation layer or other number of insulation layers. Further, the first transmission line and the second transmission line of the signal path are not limited to be deposited on the most outer insulation layer of the substrate, and optionally, it can be deposited on any insulation layer inside the substrate. The via-hole transition structure could be formed through these steps: forming a via-hole, by etching process for example, and forming a conductive material inside the via-hole, by plating a conductive wall or by filing a conductive material for example. Because the via-hole transition structure passes through these conductive layers, the parasitic capacitances and the parasitic inductances are induced from the first transmission line, from the second transmission line, or from any conductive layers which the via-hole transition structure passes through. In sum, the characteristic response of the via-hole transition structure is dominated by a parasitic capacitance or a parasitic inductance, and the characteristic response of the via-hole structure will cause the impedance deviation in the signal path. In other word, it may cause the impedance mismatch and induce the signal reflection.

Referring to FIG. 3 and FIG. 4, in order to improve the matching between the impedance of the signal path and the system impedance, a first modulating line 262 and a second modulating line 272 are arranged on the first transmission line 242 and the second transmission line 244, respectively. The impedance of the signal path 240 is modulated by controlling the cross-sectional size of the first modulating line 262 and the second modulating line 272, for example, by modulating the line width of the first modulating line 262 and the second modulating line 272, so that the impedance of the signal path 240 is matched to the system impedance. More particularly, the characteristic response of the modulating lines 262 and 272 are determined by the cross-sectional size. The inductive responses of the modulating lines induced by shrinking the width of the modulating line compensate the capacitive response of the via-hole transition structure. Thus, the impedance match in the signal path is achieved by controlling the cross-sectional size of the modulating lines. In the present invention, the first modulating line 262 is arranged on a junction of the first transmission line 242 and the via-hole transition structure 246, and the second modulating line 272 is arranged on a junction of the second transmission line 244 and the via-hole transition structure 246. Besides having the first modulating line 262, the first transmission line 242 also has a first connection line 264, wherein one end of the first modulating line 262 is electrically connected with the via-hole transition structure 248 while the other end thereof is electrically connected with the first connection line 264. Besides having the second modulating line 272, the second transmission line 244 also has a second connection line 274, wherein one end of the second modulating line 272 is electrically connected with the via-hole transition structure 250 while the other end thereof is electrically connected with the second connection line 274.

However, other applications are not limited by the above description. Optionally, the first modulating line and the second modulating line can be arranged on other locations of the first transmission line and the second transmission line, respectively, for example, on a location far away from the via hole.

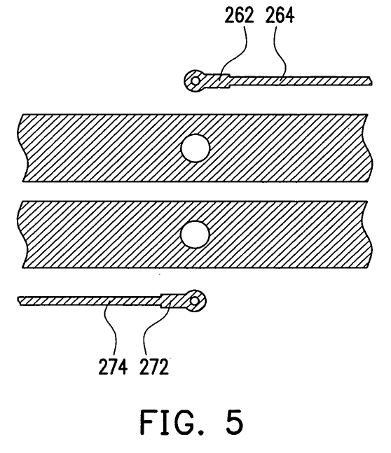

In the present embodiment, the first modulating line 262, the first connection line 264, the second modulating line 272, and the second connection line 272 are extended with a width, respectively. For example, the characteristic response of the first modulating line 262 is modulated by controlling the line width of the first modulating line 262 and the characteristic response of the second modulating line 272 is modulated by controlling the line width of the second modulating line 272. In this embodiment, the parasitic capacitance of the via-hole transition structure is compensated by the parasitic inductance on the first modulating line 262 and that on the second modulating line 272, so that the impedance of the signal path 240 is matched to the system impedance. Therefore, generally speaking, the line width of the first modulating line 262 is different from the line width of the first connection line 264, and the line width of the second modulating line 272 is different from the line width of the second connection line 274. That is, the cross-sectional size of the first modulating line 262 is different from the cross-sectional size of the first connection line 264, and the cross-sectional size of the second modulating line 272 is different from the cross-sectional size of the second connection line 274. For example, as shown in FIG. 4, the line width of the first modulating line 262 and the second modulating line 272 are reduced, so that the line width of the first modulating line 262 is smaller than the line width of the first connection line 264, and the line width of the second modulating line 272 is smaller than the line width of the second connection line 274, so that the characteristic response of the via-hole structure dominated by a parasitic capacitance is compensated by the parasitic inductances induced by the shrinking modulating lines. Further, as shown in FIG. 5, the line width of the first modulating line 262 and the second modulating line 272 are increased, so that the line width of the first modulating line 262 is larger than the line width of the first connection line 264, and the line width of the second modulating line 272 is larger than the line width of the second connection line 274, so that the characteristic response of the via-hole structure dominated by a parasitic inductance is compensated by the parasitic capacitance between the enlarging modulating line and the reference plane. Wherein, FIG. 5 schematically shows a top view of each patterned line layer of the substrate of the preferred embodiment according to the present invention under the situation that the line width of the signal path is increased.

In the preferred embodiment mentioned above, the first modulating line and the second modulating line are arranged on the first transmission line and the second transmission line, respectively. However, the application of the present invention is not limited by it. Optionally, only either arranging the first modulating line on the first transmission line or arranging the second modulating line on the second transmission line is also acceptable. Further, the controlling cross-sectional size of the signal path mentioned above is not limited to modulate its “line width”. Optionally, the impedance of the signal path also can be modulated by modulating the “cross-sectional area” of the signal path.

In summary, the via-hole structure has a characteristic response which is dominated by a parasitic inductance or a parasitic capacitance. According to the design of the transmission line and the method for modulating the impedance thereof provided by the present invention, the characteristic response of the modulating line is controlled by the cross-sectional size of the modulating line. The modulating line which has a width less than that of the transmission line provides a parasitic inductance to compensate the capacitive response of the via-hole structure. On the other hand, the modulating line which has a width larger than that of the transmission line provides a parasitic capacitance to compensate the inductive response of the via-hole structure. Thus, it is achieved the object to obtain a signal path with better impedance matching.

Although the invention has been described with reference to a particular embodiment thereof, it will be apparent to one of ordinary skill in the art that modifications to the described embodiment may be made without departing from the spirit of the invention. Accordingly, the scope of the invention will be defined by the attached claims not by the above detailed description.

1. A signal path, passing through a via hole of a substrate, comprising:
a first transmission line, arranged on any one insulation layer of the substrate;
a second transmission line, arranged on any one insulation layer of the substrate; and
a via-hole transition structure which generates a characteristic response, formed in the via hole of the substrate, wherein one end of the via-hole transition structure is electrically connected with the first transmission line while the other end thereof is electrically connected with the second transmission line, wherein the first transmission line has a first modulating line, and a cross-sectional size of the first modulating line is different from the cross-sectional size of the other portion of the first transmission line, so that the characteristic response of the via-hole transition structure is compensated by the first modulating line.

2. The signal path of claim 1, wherein the cross-sectional size of the first modulating line is a line width of the first modulating line.

3. The signal path of claim 1, wherein the cross-sectional size of the first modulating line is a cross-sectional area of the first modulating line.

4. The signal path of claim 1, wherein the first modulating line is arranged on a location of a junction of the first transmission line and the via-hole transition structure.

5. The signal path of claim 1, wherein the cross-sectional size of the first modulating line is larger than the cross-sectional size of the other portion of the first transmission line to compensate the characteristic response dominated by a parasitic inductance.

6. The signal path of claim 1, wherein the cross-sectional size of the first modulating line is smaller than the cross-sectional size of the other portion of the first transmission line to compensate the characteristic response dominated by a parasitic capacitance.

7. The signal path of claim 1, wherein the second transmission line has a second modulating line, and a cross-sectional size of the second modulating line is different from the cross-sectional size of the other portion of the second transmission line, so that the characteristic response of the via-hole transition structure is also compensated by the second modulating line.

8. The signal path of claim 7, wherein the cross-sectional size of the second modulating line is a line width of the second modulating line.

9. The signal path of claim 7, wherein the cross-sectional size of the second modulating line is a cross-sectional area of the second modulating line.

10. A signal path, passing through a via hole of a substrate, comprising:
a first transmission line, arranged on any one insulation layer of the substrate;
a second transmission line, arranged on any one insulation layer of the substrate; and
a via-hole transition structure having a characteristic response, formed in the via hole of the substrate, wherein one end of the via-hole transition structure is electrically connected with the first transmission line while the other end thereof is electrically connected with the second transmission line, wherein the first transmission line has a first modulating line and a first connection line and the second transmission line has a second modulating line and a second connection line, wherein one end of the first modulating line is electrically connected with the via-hole transition structure while the other end thereof is electrically connected with the first connection line and one end of the second modulating line is electrically connected with the via-hole transition structure while the other end thereof is electrically connected with the second connection line, and a cross-sectional size of the first modulating line is different from the cross-sectional size of the first connection line and a cross-section size of the second modulating line is different from the cross-sectional size of the second connection line, so that the characteristic response of the via-hole transition structure is compensated by the first modulating line and the second modulating line.

11. The signal path of claim 10, wherein the cross-sectional size of the first modulating line is a line width of the first modulating line and the cross-sectional size of the second modulating line is a line width of the second modulating line.

12. The signal path of claim 10, wherein the cross-sectional size of the first modulating line is a cross-sectional area of the first modulating line and the cross-sectional size of the second modulating line is a cross-sectional area of the second modulating line.

13. The signal path of claim 10, wherein the cross-sectional size of the first modulating line is larger than the cross-sectional size of the first connection line and the cross-sectional size of the second modulating line is larger than the cross-sectional size of the second connection line to compensate the characteristic response dominated by a parasitic inductance.

14. The signal path of claim 10, wherein the cross-sectional size of the first modulating line is smaller than the cross-sectional size of the first connection line and the cross-sectional size of the second modulating line is smaller than the cross-sectional size of the second connection line to compensate the characteristic response dominated by a parasitic capacitance.

15. A signal path, passing through a via hole of a substrate which comprises a plurality of conductive layers and a plurality of insulation layers alternately laminated, comprising:
a first transmission line, arranged on a first conductive layer of the substrate;
a second transmission line, arranged on a second conductive layer of the substrate;
a first reference plane, arranged on a third conductive layer of the substrate adjacent to the first conductive layer and disposed between the first conductive layer and the second conductive layer, and
a via-hole transition structure which generates a characteristic response, formed in the via hole of the substrate, wherein one end of the via-hole transition structure is electrically connected with the first transmission line while the other end thereof is electrically connected with the second transmission line, wherein the first transmission line has a first modulating line, and a cross-sectional size of the first modulating line is different from the cross-sectional size of the other portion of the first transmission line, so that the characteristic response of the via-hole structure is compensated by the first modulating line.

16. The signal path of claim 15, wherein the first reference plane is a power plane or a ground plane.

17. The signal path of claim 15, wherein the signal path further comprises a second reference plane between the first conductive layer and the second conductive layer arranged on a fourth conductive layer adjacent to the second conductive layer.

18. The signal path of claim 17, wherein the second transmission line has a second modulating line, and a cross-sectional size of the second modulating line is different from the cross-sectional size of the other portion of the second transmission line, so that the second modulating line provides a second modulating parasitic inductance to compensate the equivalent parasitic capacitance of the via-hole transition structure.

19. The signal path of claim 15, wherein the cross-sectional size of the first modulating line is larger than the cross-sectional size of the first connection line to compensate the characteristic response dominated by a parasitic inductance.

20. The signal path of claim 15, wherein the cross-sectional size of the first modulating line is smaller than the cross-sectional size of the first connection line to compensate the characteristic response dominated by a parasitic capacitance.
